(19) United States
(12) Patent Application Publication
(10) Pub. No.: US 2008/0099957 A1
(43) Pub. Date: May 1, 2008

(54) Mold Assembly Component, Clip, and Method of Production

(76) Inventors: Nicolean PETROU, San Diego, CA (US); Vladimir Rangel ALONSO, San Diego, CA (US)

Correspondence Address: FRANK G MORKUNAS, 7750 DAGGET ST, SUITE 203, SAN DIEGO, CA, 92111, US

(21) Appl. No.: 11/554,710

(22) Filed: Oct. 31, 2006

(51) Int. Cl. B29C 45/00

(52) U.S. Cl. 264/328.1; 264/328.8

(57) ABSTRACT

A four-plate mold assembly for producing a single-piece biasing clip. The four plate sections include a lower plate with a cavity to form the lower clip member; an upper plate with a cavity to form the upper clip member; and two intermediate plates in between the upper and lower plates which are separable from each other defining a parting line.

The clip is a single-piece biasing clip adapted to receive and retain a garment hanger in a rod space of the and to receive and retain wearing apparel.

Making the single-piece clip comprises placing all plate sections together, introducing molten material to the mold assembly, and allowing it to harden. After it has hardened, the upper plate is removed exposing the top clip member, followed by removal of each intermediate plate to expose the bottom clip member. The clip is then removed from the bottom plate.

### CROSS REFERENCES TO RELATED APPLICATIONS

None.

### STATEMENT REGARDING FEDERALLY-SPONSORED RESEARCH OR DEVELOPMENT

Not applicable.

### BACKGROUND

This subject matter of this disclosure relates to an improvement in injection molding, and more particularly to the mold assembly component, a single-piece clip assembly produced therefrom, and the novel process involved in the production.

Conventionally mold assemblies and typical mold design for injection molding requires a core [male] and cavity insert [female] for the finished injection-molded part. Generally core and cavity inserts form the actual surfaces of the finished injection-molded part. The core and cavity conform to the shape of the finished part with allowance for shrinkage as the molded part cools. The core and cavity inserts are forced together by a mold press prior to casting a part. After the part is cast and has cooled sufficiently, the press separates the core and cavity inserts to release the finished part.

The complete injection-mold assembly is a movable framework that holds the core and cavity inserts in the molding press and allows the mold to open and close. It also supports the systems that feed molten material to the mold cavity and supply coolant to remove heat from the mold.

In designing the core and cavity inserts parting lines between the core and the cavity must be carefully selected and designed so that the surfaces have no draft angle or ability to lock in the mold. This capability enables designers to correct molded-part models before giving them to tool designers.

The more complex the finished part, the more complex the design for the mold assembly. A single mold-assembly currently does not exist to make a clip with an upper section and a lower section, a biasing means, an openable and grip-capable mouth at one end with pressing means at the other end for opening the mouth. To make such a clip, generally the process requires two mold assemblies; one for the upper section and one for the lower section. This is following by manual inclusion of a biasing member to connect the two sections.

The mold assembly component of the present disclosure contemplates a single mold assembly component to produce such a clip. Additionally, the process of manufacture for the clip and the finished clip are equally novel and form essential components of this disclosure. The terms used herein as front, rear or back, top, and bottom are relative terms used for administrative clarity to assist in describing relative location of structure and are not terms of limitation inasmuch as the mold assembly component may be rotated 180° thereby making the front the back and the back the front. It may be turned upside-down thereby making the top the bottom and the bottom the top.

The foregoing has outlined some of the more pertinent objects of the subject matter of this disclosure. These objects should be construed to be merely illustrative of some of the more prominent features and applications of the subject matter of this disclosure. Many other beneficial results can be attained by applying the disclosed subject matter of this disclosure in a different manner or by modifying the subject matter of this disclosure within the scope of the disclosure. Accordingly, other objects and a fuller understanding of the subject matter of this disclosure may be had by referring to the summary of the subject matter of this disclosure and the detailed description of the preferred embodiment in addition to the scope of the subject matter of this disclosure defined by the claims taken in conjunction with the accompanying drawings.

### SUMMARY

The above-noted problems, among others, are overcome by the subject matter of this disclosure. Briefly stated, the subject matter of this disclosure contemplates a mold assembly component for producing a single-piece biasing clip. The mold assembly component having four plate sections: a first lower base plate with a cavity to form the lower clip member; a second upper base plate with a cavity to form the upper clip member; and two intermediate plate sections, alignable and separable from each other defining a parting line, in between the first base plate and the second base plate. A flow channel is defined at the parting line which facilitates flow of molten material between the first and second base plates and forms the connecting tab for the two clip members.

The clip formed is a single-piece biasing clip adapted to receive an external rod-like object, such as a garment hanger, in a rod space of the clip to be held on the rod-like object and to receive externally attached wearing apparel.

The process of making the single-piece clip comprises

placing all plate sections together, introducing molten material for producing a finished product from the mold assembly component, and allowing the molten material to harden. After the molten material has hardened, the upper base plate is removed exposing the top clip member, followed by removal of the first intermediate plate and the second intermediate plate thereby exposing the bottom clip member. The clip is then removed from the bottom base plate.

The foregoing has outlined the more pertinent and important features of the subject matter of this disclosure in order that the detailed description that follows may be better understood so the present contributions to the art may be more fully appreciated. Additional features of the subject matter of this disclosure will be described hereinafter which form the subject of the claims. It should be appreciated by those skilled in the art that the conception and the disclosed specific embodiment may be readily utilized as a basis for modifying or designing other structures and methods for carrying out the same purposes of the subject matter of this disclosure. It also should be realized by those skilled in the art that such equivalent constructions and methods do not depart from the spirit and scope of the subject matter of this disclosure as set forth in the appended claims.

### BRIEF DESCRIPTION OF THE DRAWINGS

For a fuller understanding of the nature and objects of the subject matter of this disclosure, reference should be had to the following detailed description taken in conjunction with the accompanying drawings in which:

FIG. 1 is a perspective view of the mold assembly component.

FIG. 2 is an exploded perspective view of the mold assembly component and product clip.

FIG. 3 is a bottom plan view of the second base plate of the mold assembly component.

FIG. 4 is a top plan detailed view of the second intermediate core section.

FIG. 5 as taken on line 5-5 of FIG. 4 is an front elevation view of the second intermediate core section.

FIG. 6 as taken on line 6-6 of FIG. 4 is bottom plan detailed view of the second intermediate core section.

FIG. 7 is bottom plan detailed view of the first intermediate core section.

FIG. 8 as taken on line 8-8 of FIG. 7 is an rear elevation view of the first intermediate core section.

FIG. 9 as taken on line 9-9 of FIG. 7 is s top plan detailed view of the first intermediate core section.

FIG. 10 is top plan view of the first intermediate core section and the second intermediate core section abutting each other.

FIG. 11 is bottom plan view of the first intermediate core section and the second intermediate core section abutting each other.

FIG. 12 is a perspective view of the clip.

FIG. 13 is a end view of the clip as taken on line 13-13 of FIG. 12.

FIG. 14 is a detailed side elevation view of the stop plate of the second clip member of the clip.

FIG. 15 is a detailed front elevation view of the stop plate of the second clip member of the clip.

FIG. 16 is an exploded side view of the clip with the bias component detached.

FIG. 17, as taken on line 17-17 of FIG. 16, is a plan view of inner side of the lower clip member.

FIG. 18, as taken on line 18-18 of FIG. 16, is a plan view of inner side of the upper clip member.

FIG. 19 is a top plan view of the clip.

FIG. 20, as taken on line 20-20 of FIG. 19, is a cut-away view of the clip.

FIG. 21, as taken on line 21-21 of FIG. 19, is a cut-away view of the clip.

### DETAILED DESCRIPTION

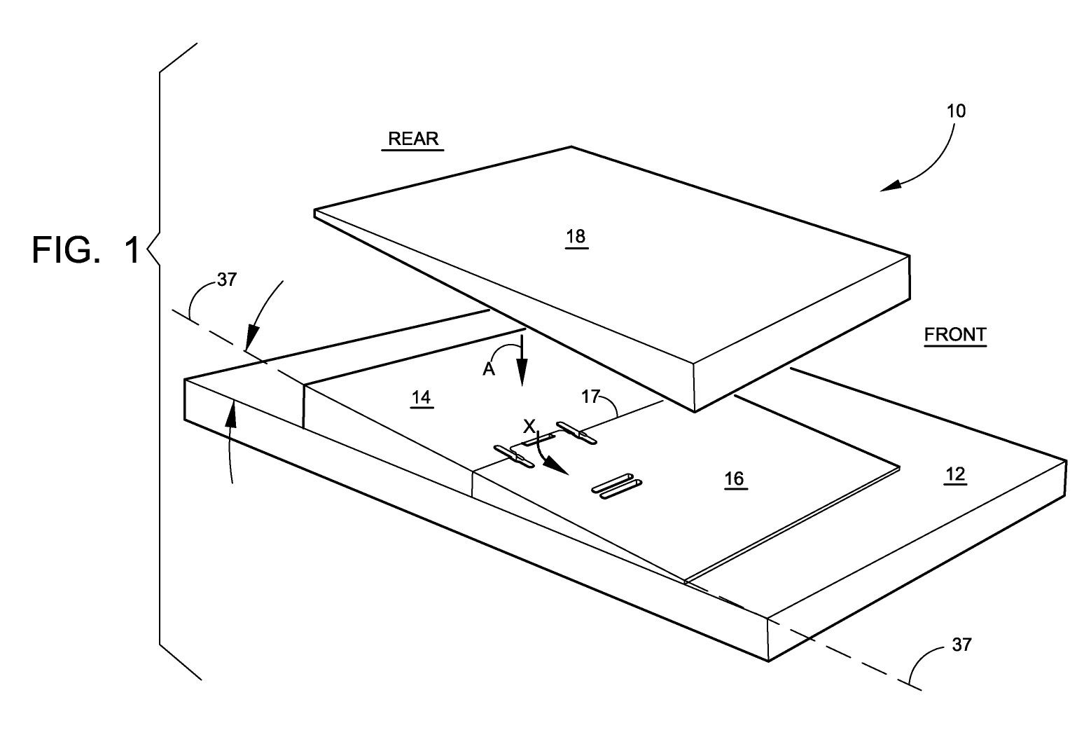

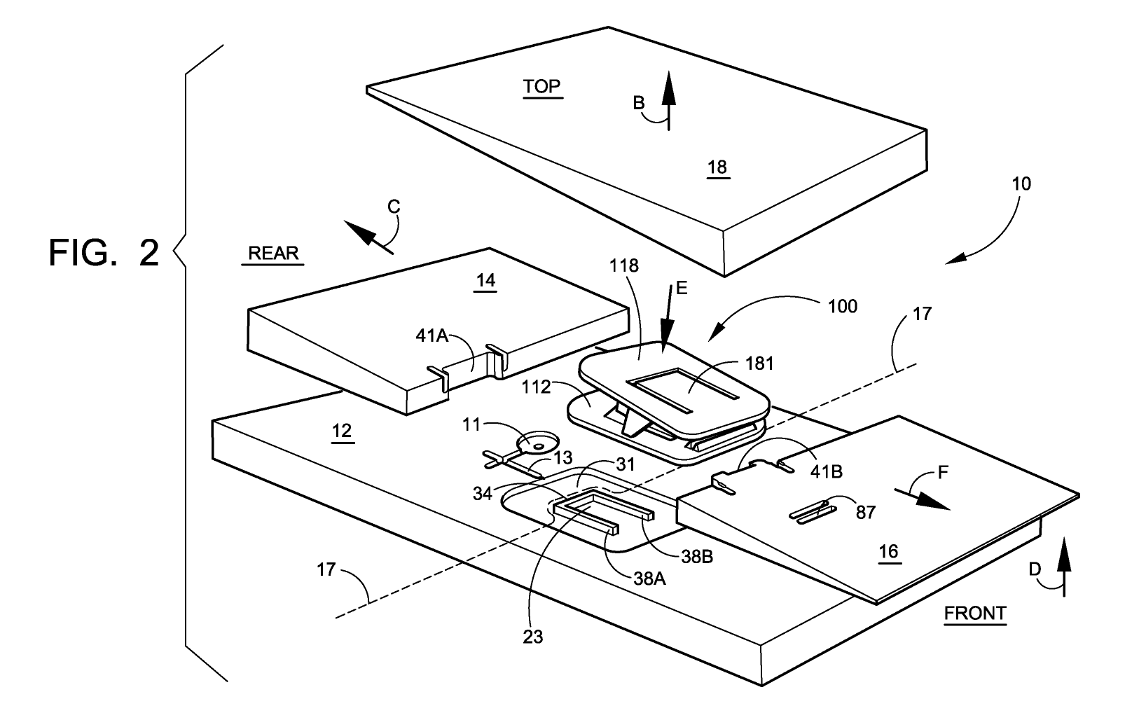

Referring now to the drawings in detail and in particular to FIGS. 1 and 2, reference character 10 and 100 generally designates a mold assembly component and clip constructed therefrom in accordance with a preferred embodiment of the subject matter of this disclosure. For administrative clarity, the mold assembly component 10 is shown to produce only one clip 100. It must be understood that the mold assembly component 10 may be one of many such individual assemblies on a single molding apparatus capable of producing multiple clips 100 during one cycling process.

This assembly 10 has a first base plate 12, a second base plate 18, and two intermediate plate sections; a first or front section 16 and a second or rear section 14. As addressed earlier, the terms front and rear as used herein are relative terms and used for administrative clarity, not by way of limitation. The “front” could be the rear and the “rear” could be the front. These are merely labels assigned to facilitate understanding.

The two intermediate plate sections 14, 16 are placed on top of the first base plate 12 and are mated with each other defining a parting line 17. The two intermediate plate sections 14, 16 are wedge-shaped and as illustrated herein slope downward from the rear of the second intermediate plate section 14 to the front of the first intermediate plate section 16 defining an angled plane 37 ranging from approximately between 10° to approximately 45°. Next, and basically in the direction of Arrow A, a wedge-shaped second base plate 18 is placed on top of the two intermediate plate sections 14, 16.

As will be described later, this wedge-shape acts to create a better bias component for the product single-piece clip 100 but the respective plates need not bear any angle or be wedge-shaped. The rod space 190 of the produced clip 100, when an external rod is placed therein [to be described in detail later], forces the mouth of the clip 100 into a biasing closed mode. The wedge-shaped component plates, however, is the preferred embodiment.

In this regard, the top of the second base plate 18 is basically parallel to the first base plate 12 whereas the underside of the second base plate 18 slopes upward from the front to the rear in a matching angle to the angled plane 37. More details on the cavities and cuts in the first base plate 12, the second base plate 18, and the two intermediate plate sections 14, 16 will follow later to fully describe how the clip 100 forms.

After the two intermediate plate sections 14, 16 are placed on the first base plate 12 and the second base plate 18 is placed on the two intermediate plate sections 14, 16, a molten material is introduced into the mold component assembly 10 through an entry port 11. As illustrated here, such port 11 is in the bottom or first base plate 12 but could also be on any other section of the mold component assembly 10.

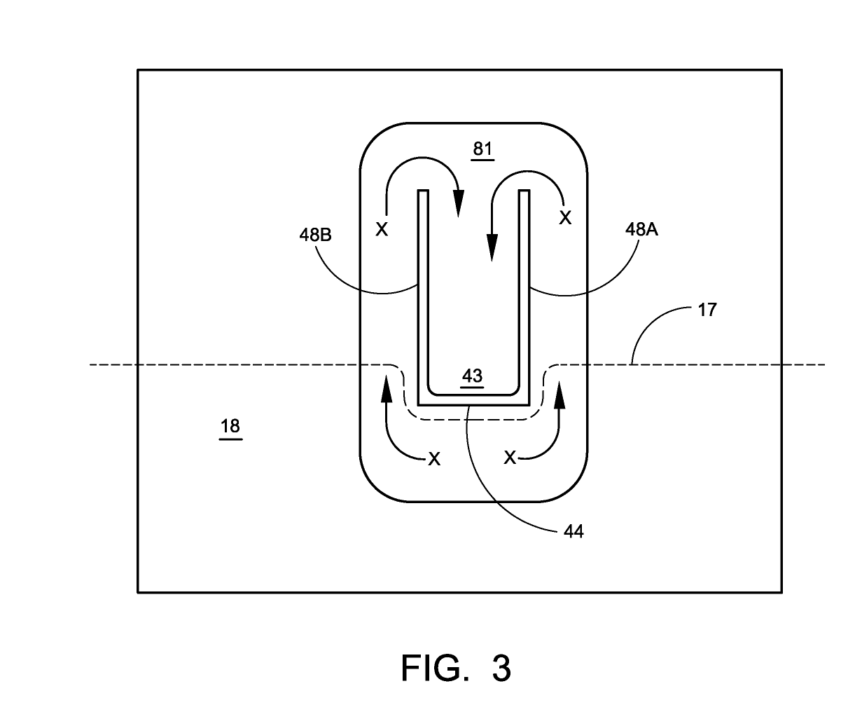

The molten material will flow into the entry channel 13 and enter and fill the first cavity space 31 and spaces in the two intermediate plate sections; said spaces to be detailed later. The molten material will then traverse the two intermediate plate sections 14, 16 through a flow channel 41 formed in these two intermediate plate sections 14, 16 and enter and fill the second cavity space 81 on the underside of the second base plate 18 [illustrated in FIG. 3]. In the process of flow all cuts which form the spaces for molten material in the respective intermediate plate sections 14, 16 and the flow channel 41 will fill with molten material to produce the clip 100.

After all the spaces of the mold assembly component 10 have filled with molten material, the molten material will be cooled and the part produced thereby, clip 100, will be removed. First in this process is the removal of the second base plate 18 in the general direction of Arrow B. The second intermediate plate section 14 is moved in the general direction of Arrow C. Because of the preferred wedge shape of the two intermediate plate sections 14, 16, removal in this direction is easily facilitated.

The process here may now take two separate directions. In one process, the terminal point [front] of the first intermediate plate section is 16 lifted in the general direction of Arrow D thereby lifting and slightly dislodging the clip 100 held in the first base plate 12. The first intermediate plate section 16 may then be removed in the general direction of Arrow F and the clip 100 easily removed from the first base plate 12. To assist in this procedure, the rear end of the clip 100 may be depressed in the direction of Arrow E.

In a second process, after removal of the second intermediate plate section 14 as described above, the clip 100 may be depressed in the direction of Arrow E thereby opening the front side [mouth] of the clip 100 causing it to move away from the first intermediate plate section 16 whereupon the first intermediate plate section 16 may be removed in the general direction of Arrow F and D in that order or Arrow D and F in that order. This leaves the clip 100 seated and fully exposed in the first base plate 12 for easy removal therefrom.

The cavity space 31 in the first base plate 12 has two upraised side ridges 38A/B approximately parallel to each other connected at one end by a similarly upraised end ridge 34. The end ridge 34 may be frontward of the parting line 17 as illustrated in this figure or may be rearward of the parting line 17. In either event the end ridge 34 should be in communication with the flow channel 41 previously mentioned and later to be fully described and the backplate 41A in such a fashion as to form the first arm 181, the second arm 121, and the connecting tab 141 of the clip 100 as later described in detail.

These side ridges 38A/B and end ridge 34 form a component of the clip 100 and one element of its biasing component. The end ridge 34 aids and facilitates the flow of molten material to, in, and through the two intermediate plate sections 14, 16 and to and in the second base plate 18.

The height of the ridges 34, 38A/B, should be as high as the cut forming the cavity in the first base plate 12 is deep. This is necessary to form the opening 123 about the second arm 121 in the second clip member 112 which forms the biasing components of the clip 100 all of which is described later.

The under side of the second base plate 18 is illustrated in FIG. 3. It has virtual mirror-image side ridges 48A/B and end ridge 44 as of the respective ridges of the first base plate 12. Reference character X generally designates the flow of molten material into and around the second base plate 18. A flow space 43 is defined by the end ridge 44 and the parting line 17. A similar flow space 23 is defined in the first base plate 12.

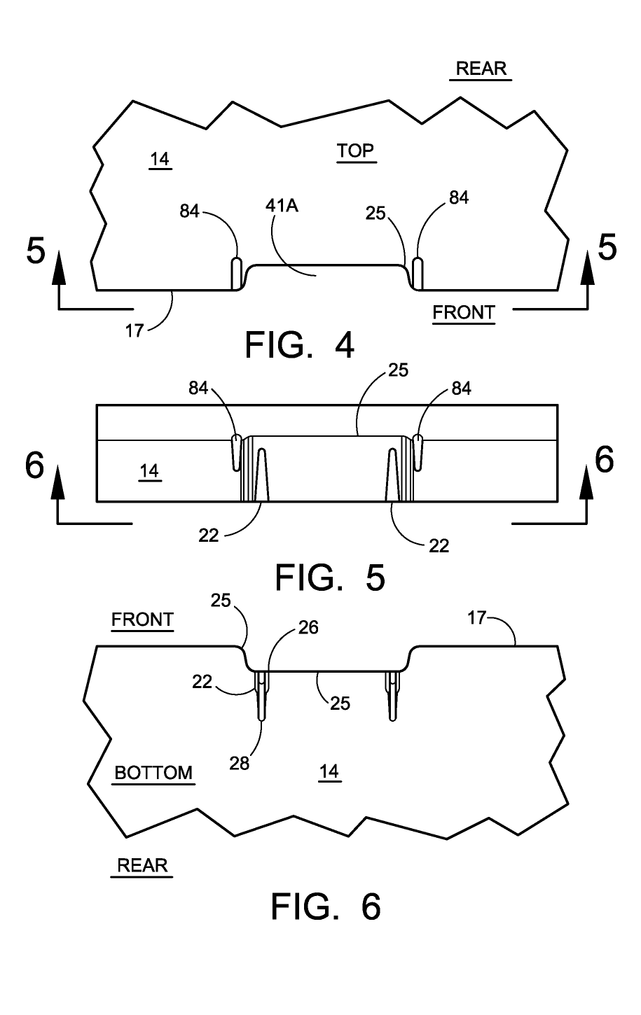

Reference is now made to FIGS. 4 through 11, the two intermediate plate sections 14, 16. FIG. 4 is the second intermediate plate section 14 as viewed from its top side. As viewed here, the rear, upper end of the slope, is at the top of the illustrated drawing and the front is at the bottom of the illustrated drawing. There is a recess 25 on the front end of the second intermediate plate section 14 with a back plate 41A.

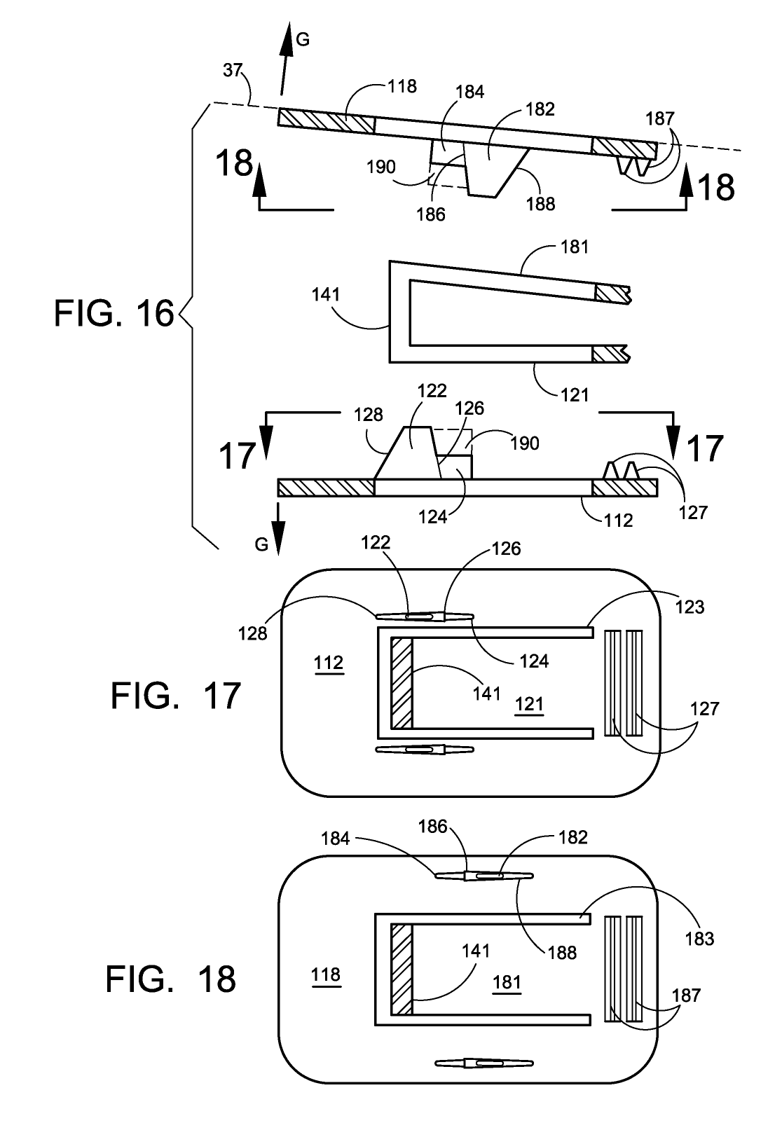

A tapered cut 84 is on each outer side of the recess 25. As seen in FIG. 5, this tapered cut 84 begins at the top and tapers and extends downward. The tapered cut 84 does not extend and cut completely through the second intermediate plate section 14. This, when filled with molten material, will form a portion of the clip 100 [i.e., the extension 184 of the pivot plate 182 as shown in FIGS. 16 through 18].

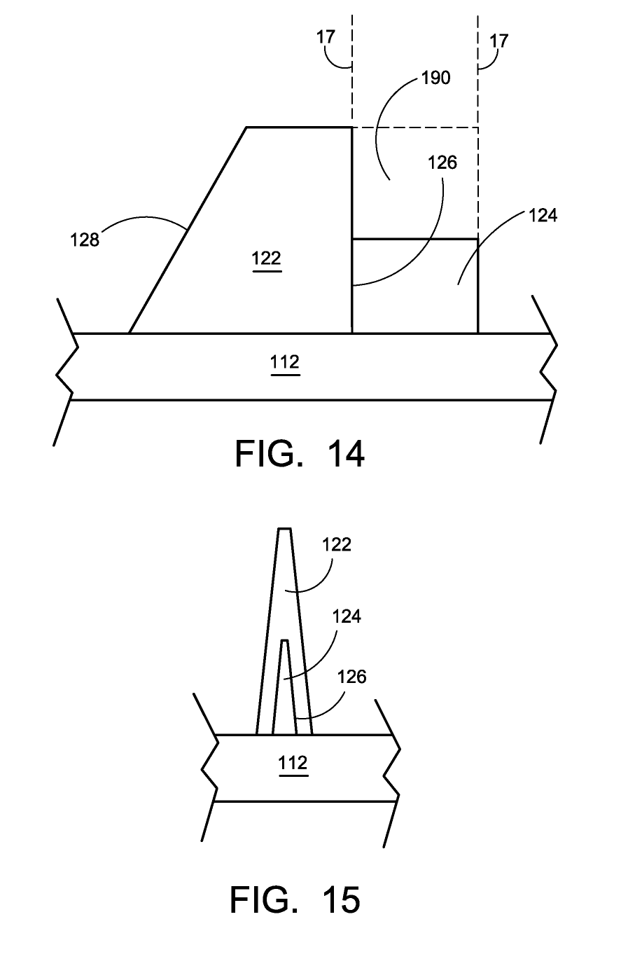

FIGS. 5 and 6 illustrate a longer tapered cut 22 which begins at the bottom of the second intermediate plate section 14 and tapers and extends upward but not cut completely through the second intermediate plate section 14. This, when filled with molten material, will form a different portion of the clip 100 [i.e., the stop plate 122 of the second clip member 112 shown in FIGS. 14 through 18].

Reference character 28 is the angled cut in the tapered cut 22 which will form the angle 128 of the stop plate 122 and reference character 26, after mating with tapered cut 24 of the first intermediate plate section 16, is the step cut for the tapered cut 22 which forms the step 126 of the stop plate 122. This configuration makes the formed stop plate 122 wider than its extension 126 [FIGS. 14 and 15 refer] and also facilitates removal of the clip 100 formed.

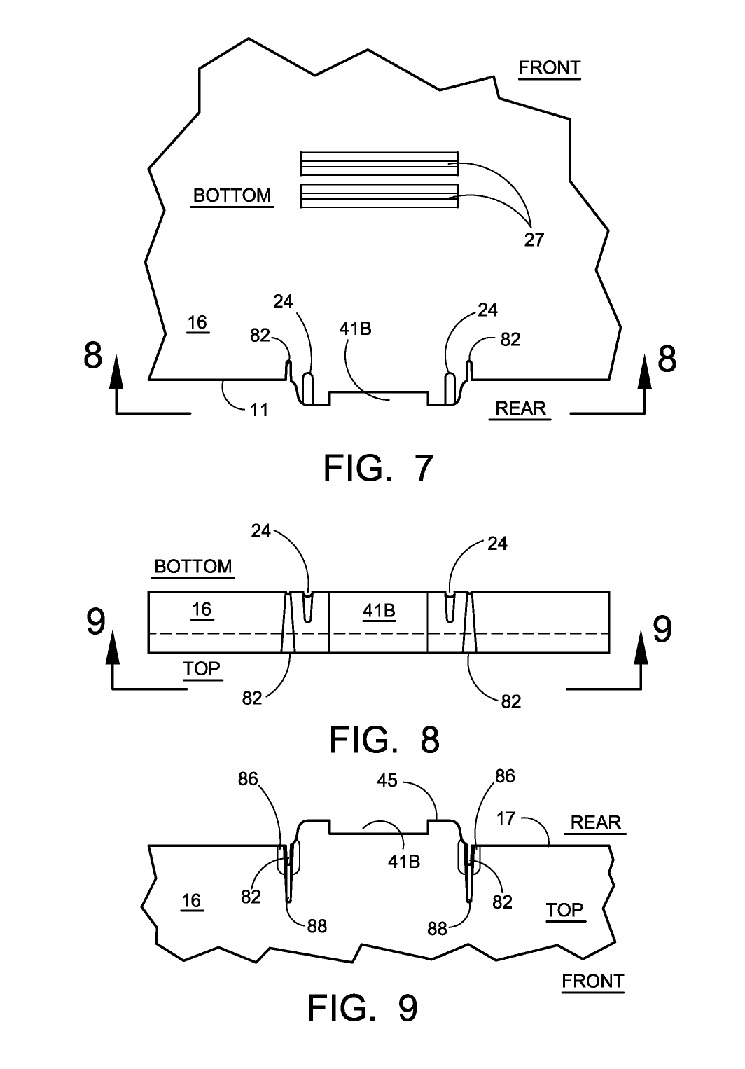

Similar figures are presented for the first intermediate plate section 16 in FIGS. 7 through 9. FIG. 7 is a view from the under side [bottom] of the first intermediate plate section 16 with the top of that drawing representing the front of the first intermediate plate section 16 and the bottom of that drawing representing the rear of the first intermediate plate section 16.

The projection 45 on the rear of this first intermediate plate section 16 aligns with the recess 25 of the second first intermediate plate section 14. The cut-out 41B in that projection from each end section forms the flow channel 41 previously mentioned which permits the flow of molten material between and for all the mold-assembly component parts and forms the connecting tab 141 for the first and second arms 181, 121 of the clip 100.

In FIG. 8, the under side [or bottom] of the first intermediate plate section 16 is at the top of the drawing and the upper side [or top] of the first intermediate plate section 16 is at the bottom of the drawing. The tapered cut 24 on each side of the projection 45 begins wider at the bottom of the first intermediate plate section 16, tapers toward the top of the first intermediate plate section 16, but does not extend to or past the top of the first intermediate plate section 16. The tapered cut 24 terminates at approximately mid-point of the depth of the rear of the first intermediate plate section 16. As earlier described, this tapered cut 24, when filled with molten material, forms the extension 124 of the stop plate 122 on the second clip member 112 of the clip 100.

A longer tapered cut 82 begins at the top of the first intermediate plate section 16 [FIG. 8, bottom of the drawing] and tapers as the cut extends to and through the bottom of the first intermediate plate section 16. This longer tapered cut 82, when mated with the tapered cut 84 on the second intermediate plate section 14 and filled with molten material, forms pivot plate 182 and extension 184 on the first clip member 118 of the clip 100. An angled cut 88 of longer tapered cut 82 angles upward and frontward and will form the angle 188 of the pivot plate 182.

Similarly as in the stop plate 122, the pivot plate 182 is wider than its extension 184 forming a step 186 from the step cut 86 formed by the mating of the second intermediate plate section 14 and the first intermediate plate section 16. This width differential facilitates removal of the finished clip 100 from the mold assembly component 10.

Transverse cuts 27 on the under side of the first intermediate plate section 16 as illustrated in FIG. 7 form the teeth 127 at the mouth on the second clip section 112 of the clip 100. Transverse cuts 87 on the upper side of the first intermediate plate section as illustrated in FIG. 2 form the teeth 187 at the mouth on the first clip section 118 of the clip 100. These transverse cuts 27, 87 are positioned such that the teeth 127, 187 formed will be in peak and valley communication with one another; i.e., the tooth projection of teeth 187 [peak] will strike the valley [space between the two teeth 127 on the second clip member 112.

The respective teeth 127, 187 of the clip 100 may be transverse to the sides of the clip 100 [i.e., relatively perpendicular thereto], or may be approximately parallel thereto, or form any angle relationship thereto. The cuts 27, 87 forming these teeth 127, 187 will be created in the respective plate as required for this purpose. The clip 100 may also be fashioned without teeth 127, 187 and accordingly, cuts 27 and 87 will not be formed in the respective plate.

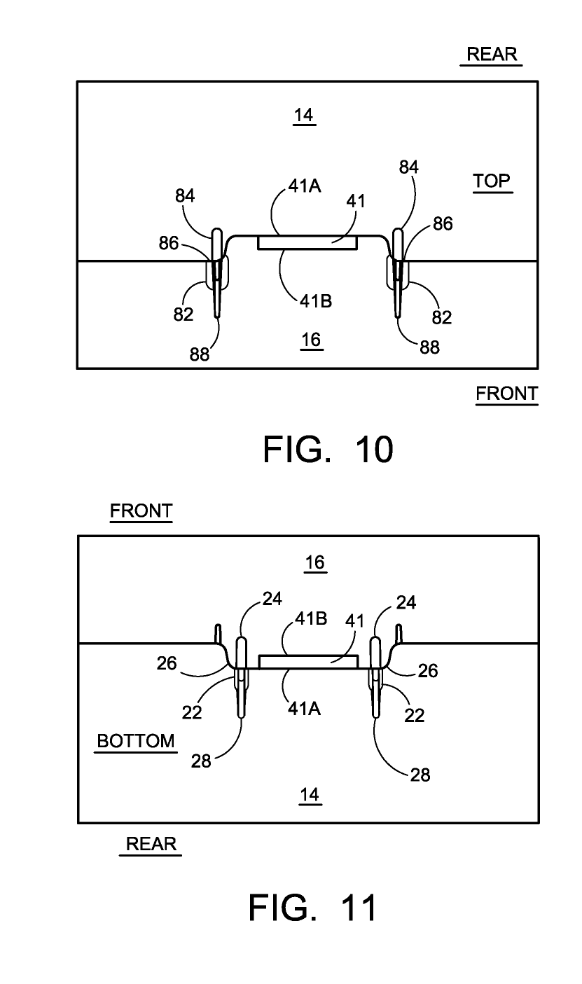

FIGS. 10 and 11 represent the two intermediate plate sections 14, 16 mated and illustrates more clearly the flow channel 41 so created by such mating. FIG. 10 is a top plan view of these two intermediate plate sections and FIG. 11 is a bottom plan view of these two intermediate plate sections. The top of the drawing of FIG. 10 represents the rear and the bottom represents the front. In FIG. 11, the top of the drawing represents the front and the bottom of the drawing represents the rear.

In FIG. 10, tapered cut 84 aligns with longer tapered cut 82. Tapered cut 84 is narrower than longer tapered cut 82 as represented in that figure by reference character 86. This narrowing will form the step 186 between the pivot plate 182 and its extension 184. The joining of the projection 45 of the first intermediate plate section 16, with its cut-out 41B, into the recess 25 of the second intermediate plate section 14, more clearly illustrates the formed flow channel 41.

In FIG. 11, tapered cut 24 aligns with longer tapered cut 22. Tapered cut 24 is narrower than longer tapered cut 22 as represented in that figure by reference character 26. This narrowing will form the step 126 between the stop plate 122 and its extension 124 on the second clip member 112 of the clip 100.

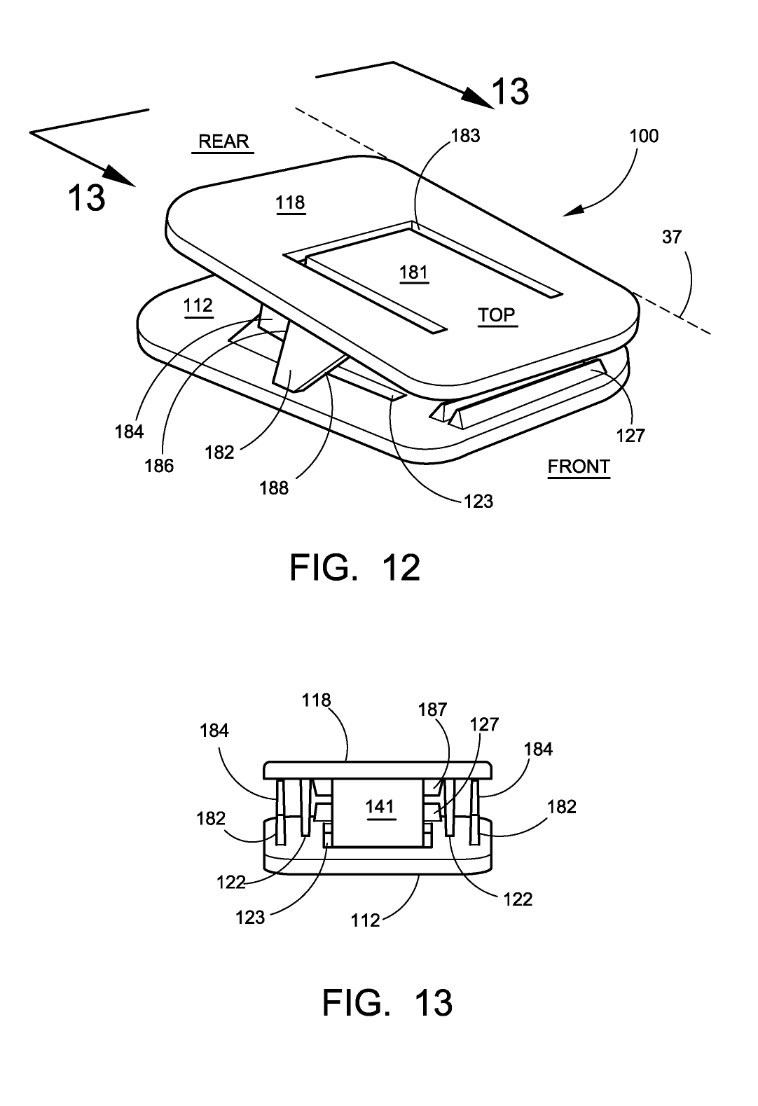

As molten material enters the first base plate 12 and fills the various voids and spaces produced by the above-described cuts, it will enter the second base plate 18 through this flow channel 41 and fill thereat the various cavities and voids produced by the above-described cuts in the first base plate 12, the second base plate 18, and the two intermediate plate sections 14, 16 to form a single-piece, biasing clip 100 as illustrated in FIGS. 12-21.

The clip 100 has a first clip member 118 [illustrated as the top member] and a second clip member 112 [illustrated as the bottom member]. As discussed earlier, the reference to top and bottom are only for administrative clarity and not by means of limitation as, if the clip 100 is turned over, the bottom physically becomes the top and the top becomes the bottom. The terms front and rear for the clip 100 are also relative and relate to the mold-assembly component 10; i.e., FIG. 2 illustrates the clip 100 removed from the mold-assembly component 10 with the mouth of the clip 100 with the teeth 127, 187 at the front of the mold-assembly component 10. Consequently, for reference purposes the rear or back of the clip 100 is the pinching end of the clip 100.

The first clip member 118 of this clip 100 is formed from the entry channel 81 and the side ridges 48A/B and end ridge 44 of the second base plate 18. These components of the second base plate 18 also form the first arm 181 on the first clip member 118 and the slot or space 183 around the first arm 181. As so formed and configured, the first arm 181 is flexible and moveable up and down like a spring-board.

The second clip member 112 of this clip 100 is formed from the entry channel 31 and the side ridges 38A/B and end ridge 34 of the first base plate 12. These components of the first base plate 12 also form the second arm 121 on the second clip member 112 and the slot or space 123 around the second arm 121. As so formed and configured, the second arm 121, like its counter-part first arm 181, is flexible and moveable up and down like a spring-board.

The angled plane 37 as earlier described for the second base plate 18 and the two intermediate plate sections 14, 16 create a clip 100 with the first clip member 118 bearing the same angle as the angled plane 37 relative to the second clip member 112.

The first arm 181 is attached to the second arm 121 by a connecting tab 141. The combination of the first arm 181, connecting tab 141, and second arm 121, and because of the spring-board effect of the respective arms and angled plane, forms a biasing component for the clip 100 which, as described briefly earlier, is made more forcefully biased by insertion of an external rod [such as a garment hanger] into the rod space 190.

This configuration allows a user to pinch the rear ends of the first clip member 118 and the second clip member 112 towards each other which in turn causes the mouth to open, expose the teeth 127, 187 thereat, and when the pinch is released, for the mouth to close and the teeth 127, 187 to grasp and hold an external object [such as a garment].

The second clip member 112 has two stop plates 122 on each side of the space 123, each of a predetermined height. The stop plates 122 project up toward the first clip member 118. One side of the stop plate 122 has an extension 124 which projects toward the mouth of the clip 100. The opposite side of the stop plate 122 has a downward angle 128 projecting toward the rear of the clip 100. The extension 124 has a height which is approximately 40% to 60% of the height of the stop plate 122.

The width of the stop plate 122 is greater than the width of the extension 124. The stop plate 122, its angle 128, its extension 124, and the respective width differences between the stop plate 122 and its extension 124 are formed by cuts 22, 26, and 28 of the second intermediate section 14, and cut 24 of the first intermediate section 16 as earlier described. FIGS. 14 and 15 detail the width differences between the stop plate 122 and its extension 124 wherein said differences in width define a step 126 thereat. FIG. 15 also illustrates the tapering structures of the stop plate 122 and its extension 124 relative to the tapered cuts which produced the stop plate 122, extension 124, and the step 126.

The first clip member 118 has two pivot plates 182 on each side of the space 183 each of a predetermined height. The pivot plates 182 project down toward the second clip member 112 and are in relative alignment with, and off-set from, the stop plates 122 as best illustrated in FIG. 20. The pivot plates 182 are virtually similar in structure as the stop plates 122.

One side of the pivot plate 182 has an angle 188 which angles upward and forward toward the mouth of the clip 100. The opposite side of the pivot plate 182 has an extension 184 projecting toward the rear of the clip 100. The extension 184 has a height which is approximately 40% to 60% of the height of the pivot plate 182.

The width of the pivot plate 182 is greater than the width of the extension 184. The pivot plate 182, its angle 188, its extension 184, and the respective width differences between the pivot plate 182 and its extension 184 are formed by cuts 82, 86, and 88 of the first intermediate section 16, and cut 84 of the second intermediate section 14 as earlier described. FIGS. 14 and 15, though of the stop plate 122, are representative of the pivot plate 182 width in relation to its extension 184 thereby defining a step 186 thereat.

Given the angled plane of the first clip member 118 to the second clip member 112 as formed by the wedge-shapes of the second base plate 18 and the two intermediate sections 14, 16; and the bias component 181, 141, 121; the clip 100 in a static or neutral mode has its mouth, with teeth 127, 187, in a nearly closed or gripable position, which is further enhanced by insertion of an external rod into the rod space 190.

As the rear ends of the respective clip members 112, 118 are pinched together, the mouth will open. The pivot plates 182 move toward the second clip member 112 and, as they strike the second clip member 112, the mouth opens. The pivot plates 182 and stop plates 122 act as a pivot point or fulcrum for the first clip member 118. Consequently, the closer the rear ends of the clip members 112, 118 are moved toward one another, the wider the mouth opens.

The bias component 121, 141, 181 exerts a resistance to the opening of the mouth biasing it to close as enhanced by the insertion of an external rod into the rod space 190. Therefore, when the pinching force on the rear ends of the clip members 112, 118 is released, the mouth closes and the teeth 127, 187 grip and hold an external object [such as an object of clothing] introduced therein by a user.

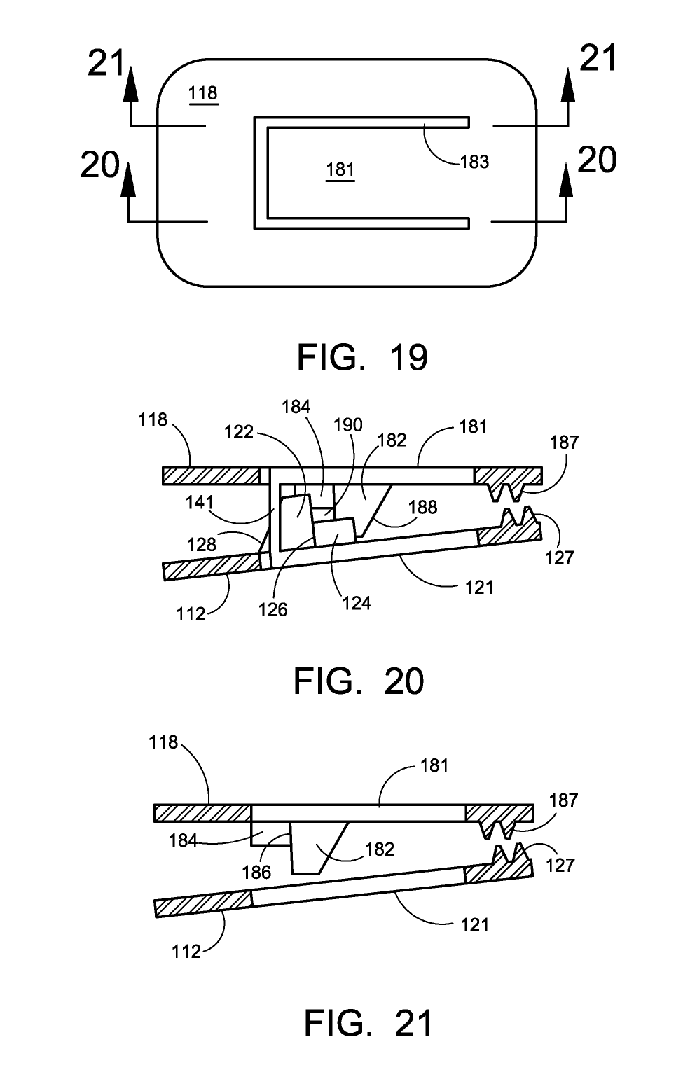

A unique feature produced by this mold-assembly component 10, the molding process, and the finished clip 100 is a rod space 190 as illustrated in FIGS. 14 and 16 in phantom line and shown in FIG. 19. This rod space 190 is created by the juxtaposition of the pivot plates 182 and its extensions 184 to the stop plates 122 and its extensions 124. With the mouth completely closed, the rod space 190 is virtually eliminated.

The rod space 190 is created by the movement of the rear ends of each clip member 112, 118 away from each other in the direction of Arrows G as illustrated in FIG. 16. The greater the distance, the larger the rod space 190 and the greater is the biasing or closing force of the mouth. The function of the rod space 190 is to receive and retain a rod-like object such as a clothes hanger [not illustrated]. A user may wish to hang slacks or a skirt on a hanger but in such a manner as not to fold or wrinkle the garment. The use of the clip 100, or two or more for better holding, facilitates such a need.

The user would insert the clip 100 from its mouth onto the rod of the hanger. This is followed by separating the rear ends of each clip member 112, 118 away from each other [Arrows G] thereby creating and exposing the rod space 190. The rod component of the hanger is slipped into the rod space 190 after which the user releases the rear ends of the clip members 112, 118 causing the respective extensions 124, 184 to bear down on the hanger and retain the hanger therein.

The potential rod space 190 of the clip 100 may be made larger by decreasing the height of each respective extension 124, 184 in the molding process. This of course also entails modifying the respective cuts 24, 84 in the respective intermediate sections 16, 14.

The present disclosure includes that contained in the present claims as well as that of the foregoing description. Although the subject matter of this disclosure has been described in its preferred forms with a certain degree of particularity, it is understood that the present disclosure of the preferred forms has been made only by way of example and numerous changes in the details of construction and combination and arrangement of parts and method steps may be resorted to without departing from the spirit and scope of the subject matter of this disclosure. Accordingly, the scope of the subject matter of this disclosure should be determined not by the embodiment[s] illustrated, but by the appended claims and their legal equivalents.

Applicant[s] have attempted to disclose all the embodiment[s] of the subject matter of this disclosure that could be reasonably foreseen. It must be understood, however, that there may be unforeseeable insubstantial modifications to subject matter of this disclosure that remain as equivalents and thereby falling within the scope of the subject matter of this disclosure.

What is claimed is:

1. A mold assembly component comprising:
(a) a first base plate having a front, a rear, a top, and a bottom;
(b) a second base plate having a front, a rear, a top, and a bottom;
(c) a core assembly in between said second base plate and said first base plate, said core assembly comprising a first intermediate plate section having a front, a rear, a top, and a bottom and a second intermediate plate section having a front, a rear, a top, and a bottom wherein said first intermediate plate section is abuttable to and separable from said second intermediate plate section defining a parting line thereat; and
(d) means for introducing molten material into said mold assembly component to produce a finished part.

2. The mold assembly component of claim 1 wherein said first base plate comprises a first cavity for receiving molten material, two side ridges in said first cavity and one end ridge in said first cavity connected to each one of said two side ridges.

3. The mold assembly component of claim 2 wherein said parting line, with said core assembly on said first base plate, is above the end ridge of said first base plate defining a flow space in said first base plate between said end ridge of said first base plate and said two side ridges of said first base plate.

4. The mold assembly component of claim 3 wherein said second base plate comprises a second cavity for receiving molten material, two side ridges in said second cavity and one end ridge in said second cavity connected to each one of said two side ridges

5. The mold assembly component of claim 4 wherein said parting line, with said second base plate on said core assembly, is above the end ridge of said second base plate defining a flow space in said second base plate between said end ridge of said second base plate and said two side ridges of said second base plate.

6. The mold assembly component of claim 5 wherein the front of said second intermediate plate section has a plate recess above the end ridge of said first base plate and in communication with the flow space of said first base plate and in communication with the flow space of said second base plate, said recess defining a back plate.

7. The mold assembly component of claim 6 wherein said first intermediate plate section has a projection in alignment with the recess of said parting line and abuttable into said recess wherein said projection further has a frontward extending cut-out having a first end and a second end, said cut-out in communication with the flow space of said first base plate and in communication with the flow space of said second base plate defining a flow channel thereat for molten material to flow from said first base plate, through said flow channel, into said second base plate.

8. The mold assembly component of claim 7 wherein said first end and said second end of said cut-out are aligned with the side ridges of said first base plate and the side ridges of said second base plate.

9. The mold assembly component of claim 7 further comprising a frontward cut on each side of said projection adapted to receive molten material to form a portion of a pivot plate on a clip.

10. The mold assembly component of claim 9 wherein the top of said first intermediate plate section further comprises an angling cut on each of said frontward cuts, said angling cut commencing approximately at midpoint upward of said frontward cuts and angling up and frontward from said frontward cuts to form a portion of a pivot plate on a clip.

11. The mold assembly component of claim 7 further comprising a tapered cut from the top of said second intermediate plate section on each side of said recess, said tapered cut terminating above the bottom of said second intermediate plate section wherein said tapered cut is in alignment with the frontward cut of said first intermediate plate section to form a portion of a pivot plate on a clip.

12. The mold assembly component of claim 7 wherein the bottom of said second intermediate plate section further comprises a rearward cut on each side of and within said plate recess adapted to receive molten material to form a portion of a stop plate on a clip, said rearward cut not cut through to the top of said second intermediate plate sections.

13. The mold assembly component of claim 12 further comprising a tapered cut from the bottom of said first intermediate plate section on each end side of and within said projection, said tapered cut terminating below the top of said first intermediate plate section wherein said tapered cut is in alignment with the rearward cut of said second intermediate plate section to form a portion of a stop plate on a clip.

14. The mold assembly component of claim 12 wherein the bottom of said second intermediate plate section further comprises an angling cut on each of said rearward cuts, said angling cut commencing approximately at midpoint downward of said rearward cuts and angling downward and rearward from said rearward cuts to form a portion of a stop plate on a clip.

15. The mold assembly component of claim 1 wherein said core assembly is wedge-shaped sloping downward from the rear of said second intermediate plate section to the front of said first intermediate plate section defining an angled plane.

16. The mold assembly component of claim 15 wherein the top of said second base plate is approximately parallel to the top of said first base plate and wherein the bottom of said second base plate slopes upward from the front of said second base plate to the rear of said second base plate in matching communication with said angled plane.

17. The mold assembly component of claim 15 wherein said angled plane bears an angle of approximately 10° to approximately 45°.

18. A single-piece clip comprising:
(a) a first clip member having a front and a rear and a first arm extending rearward from its front to an end point;
(b) a second clip member having a front and a rear and a second arm extending rearward from its front to an end point; and
(c) a tab having a top and a bottom, wherein the top of said tab is connected to the end point of said first arm and the bottom of said tab is connected to the end point of said second arm wherein said first arm, said second arm, and said tab in combination comprise a bias component for said clip.

19. The clip of claim 18 further comprising a pivot plate on each side of said first arm, said pivot plate extending downward from said first clip member and adapted to move toward said second clip member as the rear of said first clip member and the rear of said second clip member are moved toward each other thereby causing the front of each clip member to open and, upon release, to close.

20. The clip of claim 19 further comprising an extension on said pivot plate, said extension extending rearward of said pivot plate and downward from said first clip member to approximately mid-point of said pivot plate.

21. The clip of claim 20 further comprising stop plate on each side of said second arm, said stop plate extending upward from said second clip member and adapted to strike the first clip member as the rear of said first clip member and the rear of said second clip member are moved toward each other thereby causing the front of each clip member to open and, upon release, to close.

22. The clip of claim 21 further comprising an extension on said stop plate, said extension extending forward of said stop plate and upward from said second clip member to approximately mid-point of said stop plate.

23. The clip of claim 22 further comprising retaining means for receiving and retaining therein an external rod component.

24. The clip of claim 23 wherein said retaining means comprises a space defined between said pivot plate and its extension and said stop plate and its extension as the rear of said first clip member and the rear of said second clip member are moved away from each other.

25. A method of producing a single-piece clip comprising the steps of:
(a) obtaining a first base plate having a first cavity with two side ridges and one end ridge connected to said two side ridges, said end ridge either near to a front or to a rear of said first cavity;
(b) obtaining a second base plate having a second cavity with two side ridges and one end ridge connected to said two side ridges, said end ridge either near to a front or to a rear of said second cavity wherein either said first base plate or said second base plate further comprises receiving means for receiving molten material to produce a molded part,
(c) obtaining a two-piece core assembly having a first section, a second section, a parting line defined where said first section and said section abut, and a flow channel for receiving molten material, wherein said first section further has a terminal point at its front end;
(d) placing said core assembly onto said first base plate wherein said flow channel is in communication with said end ridge of said first base plate;
(e) placing said second base plate onto said core assembly wherein said end ridge of said second base plate is in communication with said flow channel; and
(f) introducing molten material into said receiving means to fully fill said second base plate, said first base plate, and said flow channel with molten material.

26. The method steps of claim 25 further comprising, after said molten material has hardened to form said single-piece clip, removing the second base plate from said core assembly.

27. The method steps of claim 26 further comprising removing said second section of said core assembly thereby exposing a portion of said clip.

28. The method steps of claim 27 further comprising lifting said terminal point of said first section of said core assembly thereby dislodging said clip.

29. The method steps of claim 28 further comprising removing said clip from said first base plate.

30. The method steps of claim 28 further comprising removing said first section of said core assembly.

31. The method steps of claim 27 further comprising depressing the exposed portion of said clip thereby relieving pressure from said first section of said core assembly.

32. The method steps of claim 31 further comprising removing said first section of said core assembly.

33. The method steps of claim 32 further comprising removing said clip from said first base plate.

34. The method steps of claim 26 wherein said second base plate is wedge-shaped defining an angled plane and wherein said core assembly is web-shaped in alignment with said angled plane.
